(19) United States
(12) Patent Application Publication
(10) Pub. No.: US 2026/0167038 A1
(43) Pub. Date: Jun. 18, 2026

(54) CHARGING AN EXTERNAL BATTERY USING AN ONBOARD GENERATOR

(71) Applicant: GM Global Technology Operations LLC, Detroit, MI (US)

(72) Inventors: Daniel Paul Tyiran, Troy, MI (US); Matthew J Harris, Milford, MI (US); Christopher Andrew Stanek, Lake Orion, MI (US)

(73) Assignee: GM Global Technology Operations LLC, Detroit, MI (US)

(21) Appl. No.: 18/983,456

(22) Filed: Dec. 17, 2024

(51) Int. Cl. B60L 53/62; B60L 53/16; B60L 53/18; B60L 53/57; H02J 7/00; H02J 7/16

(52) U.S. Cl. CPC B60L 53/62; B60L 53/16; B60L 53/18; B60L 53/57; H02J 7/16; H02J 7/82

(57) ABSTRACT

Presented are apparatuses, methods, and non-transitory machine-readable storage mediums for providing power to an external device using an onboard generator of an integrated system without providing power to an internal battery. In some embodiments, the integrated system may be a series hybrid vehicle and may be used to provide power to an electric vehicle.

### FIELD

The present disclosure generally relates to providing power from an onboard generator of an integrated system. Specifically, embodiments of the present disclosure relate to charging an external battery using an onboard generator in a series hybrid vehicle without charging an internal battery.

### BACKGROUND

There is an ever-increasing need to deliver an electrical charge to provide power to a variety of devices. In the event there are no readily available power sources to provide power to a device, it can be costly and inefficient to obtain power. For instance, one such device that requires power may be a rechargeable battery. The battery may be a part of, for example, an electric vehicle or plug-in hybrid vehicle, which may run out of power in remote areas where there is a lack of available power sources. In some embodiments, the devices requiring power may be immovable or difficult to transport to an available power source. In such instances, it is advantageous to have a mobile power source that is capable of providing large amount of power. In some embodiments, it may be advantageous to have a portable apparatus, such as a series-hybrid vehicle, that is capable of provide level 3 fast charging directly to an electric vehicle using an onboard generator of the apparatus.

Prior solutions may include loading a gasoline- or diesel-powered generator into a vehicle and transporting it to the location in order to provide power, but these solutions are costly, inconvenient, and time-consuming, and are capable of delivering only limited amounts of power. Further, such instances provide AC power, which enables level 1 or level 2 charging of an electric vehicle. Level 3 charging, also known as DC fast charging, delivers DC power instead of AC power, and enables significantly faster charging.

The present disclosure is directed to a robust apparatus, system, and method for delivering large amounts of power while avoiding the expenses, complexity, weight, form factor, temporal, and safety concerns associated with prior solutions.

### SUMMARY

Presented herein are certain apparatuses, systems, and methods for providing power to external devices from a moveable system. In some embodiments of the present disclosure, an apparatus configured to provide power to an external battery is provided. An apparatus may comprise a generator, a charge port, and an internal battery. An apparatus may be configured to determine whether the charge port is connected to an external battery and, if so, to determine a state of charge of the external battery, match a first voltage produced by the generator to a second voltage of the external battery based on the state of charge of the external battery, and charge the battery via the charge port and using the generator.

In some embodiments of the present disclosure, a method for charging an external battery is provided. A method includes connecting the external battery to a charge port, the charge port being associated with an internal battery and a generator. A method includes determining, using a processor and a non-transitory machine-readable storage medium encoded with program code (e.g., software, firmware, combinations thereof, etc.) executable by the processor, the state of charge of the external battery based on a determination that the charge port is connected to the external battery; matching a first voltage produced by the generator to a second voltage of the external battery based on the determined state of charge of the external battery; and charging the external battery using the generator.

In some embodiments, a non-transitory machine-readable storage medium encoded with program code executable by a processor of an apparatus, the program code executable by the processor is configured to determine whether a charge port of the apparatus is connected to an external battery and, if so, determine a state of charge of the external battery; based on the determined state of charge of the external battery, match a first voltage produced by a generator of the apparatus to a second voltage of the external battery; and charge the external battery via the charge port and using the generator.

Attendant benefits for at least some of the disclosed concepts include a novel approach to providing large amounts of power from a portable apparatus. Disclosed embodiments could, for example, enable a series-hybrid vehicle to drive to a location where an electric vehicle is stranded and provide large amounts of DC power to the electric vehicle using an onboard generator, without charging an internal battery, of the series hybrid vehicle. While prior solutions may enable level 1 or level 2 charging using a separate, portable AC generator, some embodiments of the disclosed invention may enable level 3 DC fast charging directly from an onboard generator of a series-hybrid vehicle using a charge port of the series-hybrid vehicle.

### BRIEF DESCRIPTIONS OF THE DRAWINGS

FIG. 1A is a simplified, exemplary schematic illustrating one embodiment of the present disclosure.

FIG. 1B is a simplified, exemplary schematic illustrating one embodiment of the present disclosure.

FIG. 2 is a flowchart illustrating an exemplary method for provisioning power from an onboard generator of a system to an external battery or device without charging an onboard, internal battery according to one embodiment of the present disclosure.

FIG. 3 is a flowchart illustrating another exemplary method for provisioning power from an onboard generator of a system to an external battery or device without charging an onboard, internal battery according to one embodiment of the present disclosure.

The present disclosure is capable of various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure may be embodied in many different forms. Exemplary embodiments are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise. Moreover, recitation of “first”, “second”, “third”, etc., in the specification or claims is not used to establish a serial or numerical limitation; rather, these designations may be used for ease of reference to similar features in the specification and drawings and to demarcate between similar elements in the claims. The term “battery,” as used in this disclosure, may refer to any suitable rechargeable energy storage system unless otherwise expressly limited. Additionally, the term “generator” may refer to a generator set, or genset, and may include additional components therein, such as an engine and a generator.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.”

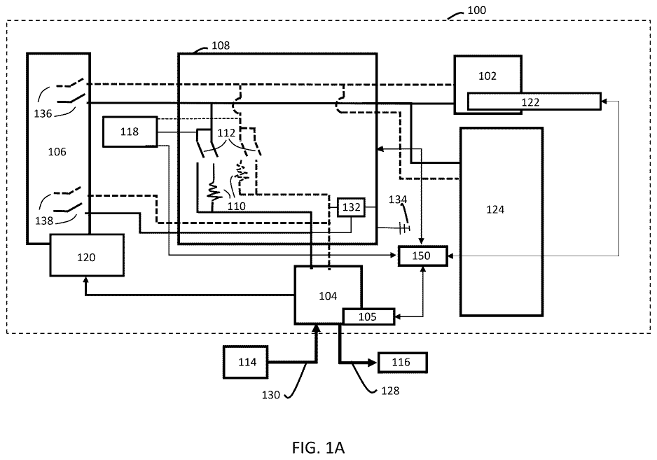

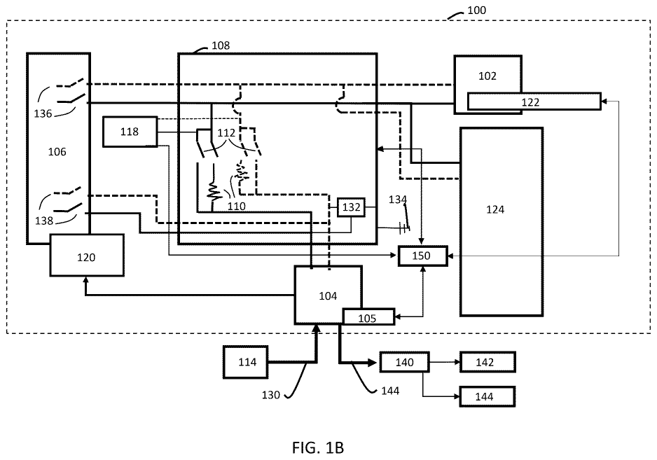

Referring now to FIG. 1A, a schematic of an apparatus 100 according to an embodiment of the present disclosure is provided. In some embodiments, apparatus 100 may be a motor vehicle such as a series hybrid vehicle. As shown in FIG. 1A, apparatus 100 may include a generator 102, an internal battery 106, and a charge port 104.

In some embodiments, apparatus 100 includes a master controller 150, which comprises a processor and a non-transitory computer-readable medium that stores program code executable by the processor for performing various steps, described in detail below. In some embodiments, master controller 150 may operate in place of or in conjunction with, generator control module 122, internal battery control module 120, charge port control module 105, and control feedback module 118. In some embodiments, one or more of generator control module 122, internal battery control module 120, charge port control module 105, and control feedback module 118 may comprise a processor and a non-transitory computer-readable medium that stores program code executable by the processor for performing one or more of the various steps described below.

In some embodiments, generator 102 may be configured to output a direct current (DC). In various embodiments, generator 102 may further be configured to provide power to the internal battery 106 or other high voltage modules. In some embodiments, generator 102 may include an engine, which may run on fuel such as, but not limited to, gasoline or diesel. In some embodiments, generator 102 may be configured to produce direct current (DC). As shown in FIG. 1A, generator 102 may include a generator control module 122, which, in certain embodiments, comprises a processor and a non-transitory computer-readable medium that stores program code executable by the processor for performing various steps. In some embodiments, generator control module 122 may be configured to receive control instructions (e.g., from master controller 150) and/or generate control instructions that may be based on received signals. In some embodiments, generator control module 122 may be configured to execute instructions to start, stop, or adjust generator 102, among other things. In some embodiments, generator control module 122 may comprise a processor and a non-transitory computer-readable medium that stores program code executable by the processor for performing various steps, including but not limited to, starting the generator, stopping the generator, and/or adjusting the output voltage of the generator. In some embodiments, generator 102 may further be configured to output a high voltage, such as, for example, voltages greater than or equal to 60V DC. For example, in some embodiments, generator 102 may be configured to produce 80 kW DC. In some embodiments, generator 102 may be configured to produce 160 kW DC, 240 kW DC, 360 kW DC, 480 kW DC, 1 MW DC, or any suitable production power amount. In some embodiments (not shown in FIG. 1A), there may be one or more additional generators configured in apparatus 100.

Internal battery 106 may be any suitable energy storage device. For example, in some embodiments, internal battery 106 may be a rechargeable lithium-ion battery. In some embodiments, internal battery 106 may be, for example, a solid state battery or a supercapacitor. In some embodiments, internal battery 106 may comprise several smaller batteries coupled together, as is known in the art. As shown in FIG. 1A, in some embodiments, internal battery 106 is part of apparatus 100, and may be configured to provide power to various components of apparatus 100. In some embodiments, internal battery 106 may also be configured to receive power from generator 102, or receive power from an external power source 114 via charge port 104. In some embodiments, internal battery 106 may be configured to be selectively connected, or disconnected, to/from any or all of the components in apparatus 100 (such as, for example, to/from generator 102 or to/from charge port 104) using any suitable means. For instance, in some embodiments, internal battery 100 may be configured to be selectively electrically connected, or electrically disconnected, via an internal battery control module 120.

In some embodiments, internal battery control module 120 may comprise a processor and a non-transitory computer-readable medium that stores program code executable by the processor for performing various steps, including but not limited to, monitoring the internal battery 106, performing operations to maintain the internal battery 106 (e.g., regulating the temperature of the battery), monitoring the state of health of the battery, monitoring the state of charge of the battery, and reporting the operational status of the battery to other controllers. In some embodiments, internal battery control module 120 may report the operational status of the battery to, for example, master controller 150 and/or generator control module 122. In some embodiments, internal battery control module 120 may be configured to receive control instructions for example, from master controller 150, generator control module 122, and/or charge port 104. In some embodiments, internal battery control module 120 may be configured to generate control instructions and may send them to master controller 150, generator control module 122, and/or charge port 104. In some embodiments, internal battery control module 120 may be configured to communicate with other systems, such as a charge station 114 or an external battery 116, and may provide information about internal battery 106, such as state of charge or charge limits, and any other functions that are suitable to be performed by a battery control module. In some embodiments, internal battery control module 120 and may connect or disconnect internal battery 106. Additionally or alternatively, apparatus 100 may, include, for example, contactors that may open or close to control the flow of current through the system at any point in the system (e.g., internal battery contactors 136 and 138), or may use any other suitable solution for stopping current flow. In some embodiments (not shown in FIG. 1A), there may be one or more additional internal batteries (in additional to internal battery 106) configured in the apparatus.

As shown in the embodiment depicted in FIG. 1A, apparatus 100 may also include a charge port 104. In some embodiments, charge port 104 may be switchable and connected to the internal battery 106 and/or connected to the generator 102. In some embodiments, charge port 104 is configured to receive a charge cable 128 and may connect to an external battery 116 via charge cable 128. In some embodiments, charge port 104 may be configured to receive a charge cable 130 and may connect to an external power source 114 via charge cable 130. In some embodiments, charge port 104 may comprise a charge port control module 105, which comprises a processor and a non-transitory computer-readable medium that stores program code executable by the processor for performing various steps, including but not limited to, determining an internal resistance value of a charge cable (such as charge cable 128 or 130). In some embodiments, apparatus 100 may include a plurality of charge ports, which may include a first charge port configured to receive charge from an external power source and a second charge port configured to provide power to an external battery.

External battery 116 may be any suitable energy storage device. In some embodiments, external battery 116 may be a rechargeable lithium-ion battery. In some embodiments, external battery 116 may be, for example, a solid state battery or a supercapacitor. In some embodiments, internal battery 106 may comprise several smaller batteries coupled together, as is known in the art. In some embodiments, external battery 116 may be configured to receive power from apparatus 100 of the present embodiment. In some embodiments, external battery 116 may be a component of or for an electric vehicle, a plug-in hybrid vehicle, or of or for any other device requiring power. In some embodiments, external battery 116 may be configured with an external battery control module (not shown in FIG. 1A), which comprise a processor and a non-transitory computer-readable medium that stores program code executable by the processor.

In some embodiments, external battery 116 may be configured to communicate using certain specified protocols, such as a standard Power Line Communication protocol. Using such a communication protocol may allow external battery 116 to communicate with apparatus 100 to share information such as, for example, the state of charge of external battery 116 or any charge limits associated with external battery 116. In some embodiments, external battery control module (not shown in FIG. 1A) may be configured to receive control instructions (e.g., from master controller 150) or generate control instructions, and may connect or disconnect external battery 116. In some embodiments, external battery control module (not shown) may be configured to communicate with other systems, such as those in apparatus 100, and may provide information about external battery 116, such as, for example, state of charge or charge limits, and any other functions that may be typically performed by a battery control module.

In some embodiments, an apparatus, such as apparatus 100 of FIG. 1B may provide power to a variety of devices requiring power (e.g., devices 142 of FIG. 1B). In some embodiments, devices 142 may not be configured to store energy. In certain embodiments, devices 142 of FIG. 1B could include, for example, tools, appliances, a home (such as home 144 of FIG. 1B), or any suitable device that requires power. In certain embodiments, an adapter (e.g., adapter 140 of FIG. 1B) may be configured as part of an apparatus (e.g., apparatus 100) or as a separate component (configured to be coupled with charge port 104, using, for example, charge cable 140). In some embodiments, an adapter (e.g., adapter 140) converts power from DC to AC. In some embodiments, an adapter (e.g., adapter 140 of FIG. 1B) includes a step up or step down voltage converter.

Still referring to FIG. 1A, in some embodiments, apparatus 100 may connect to external battery 116 using a charge cable 128 that has a unique internal resistance value. In some embodiments, charge cable 128 is configured with a unique resistance value. In some embodiments, charge port control module 105 determines the resistance value of the charge cable attached to charge port 104 (e.g., charge cable 128 or 130). In some embodiments, a determination of a unique resistance value of charge cable 128 indicates that external battery 116 is coupled to charge port 104. In some embodiments, based on a determination of a unique resistance value, charge port control module 105 may send a signal to master controller 150 and/or any of the other control modules in the system (e.g., internal battery control module 120, generator control module 122, etc.) indicating that apparatus 100 is connected to an external battery (e.g. external battery 116) and/or that apparatus 100 is not connected to an external power station, (e.g. external power station 114).

As illustrated in FIG. 1A, in some embodiments, an external power source 114 is any suitable device or system configured to provide power the apparatus 100. In some embodiments, external power source 114 is, for instance, a grid-tied charger.

In some embodiments, referring to FIG. 1A, high voltage distribution module 108 is designed to control the delivery of power to various systems and components of apparatus 100 (e.g., internal battery 106, generator 102, charge port 104, etc.). In some embodiments, as shown in FIG. 1A, high voltage distribution module 108 includes precharge contactors 110 and main contactors 112. In some embodiments, precharge contactors 110 and main contactors 112 may be configured to connect generator 102 with charge port 104 via a switchable connection. In some embodiments, precharge contactors 110 and main contactors 112 are configured to operate at high voltages (e.g., voltages greater than or equal to 60V DC). In some embodiments, precharge contactors 110 and main contactors 112 are configured in an open position as depicted in the illustrated embodiment of FIG. 1A, in which no current runs between generator 102 and charge port 104, or in a closed position (not shown), or in a combination of open and closed positions (not shown). In some embodiments, high voltage distribution module 108 comprises a processor and a non-transitory computer-readable medium that stores program code executable by the processor for performing various steps, including but not limited to, opening and closing precharge contactors 110 and/or main contactors 112, generating signals indicating the state of precharge contactors 110 and/or main contactors 112, receiving signals from certain controllers/control modules in apparatus 100 (e.g., master controller 150, internal battery control module 120, generator control module 122, and/or charge port module 105), etc., In various embodiments, to prevent damage to the system or its components, precharge contactors 110 may be closed before main contactors 112 are closed, in order to allow electrical current to flow in a controlled manner until the voltages at a source voltage and a second voltage are comparable, then main contactors 112 may also be closed, at which point current may run freely.

In some embodiments, high voltage distribution module 108 comprises high voltage busbars (e.g., busbars capable of handling voltages greater than or equal to 60V DC). In some embodiments, high voltage distribution module 108 may be configured with control feedback module 118. In some embodiments, control feedback module 118 comprises a processor and a non-transitory computer-readable medium that stores program code executable by the processor for performing various steps, including but not limited to, monitoring currents and/or voltages across main contactors 112 and precharge contactors 110, generating signals indicating the voltages and/or currents across main contactors 112 and precharge contactors 110 to send to one or more of the controllers/control modules of apparatus 100 (e.g., master controller 150, internal battery control module 120, generator control module 122, charge port module 105, etc.). In some embodiments, high voltage distribution module 108 may receive signals from one or more other controllers/control modules of apparatus 100 (e.g., master controller 150, internal battery control module 120, generator control module 122, control feedback module 118, charge port module 105, etc.), indicating when to open or close precharge contactors 110 and/or main contactors 112.

In some embodiments, as shown in FIG. 1A, apparatus 100 may include an isolator module 132 and a ground 134.

In some embodiments, as shown in FIG. 1A apparatus 100 may include one or more High Voltage Modules 124. High voltage modules 124 may include a variety of components configured to operate using high voltages, including, but not limited to, electric motors.

Although not illustrated in FIG. 1A, various embodiments may include additional features within apparatus 100, such as, for example, a second generator, a second internal battery, a second charge port, and/or additional modules that may require power, such as, for example, electric motors, instruments, computers, etc. and necessary, corresponding control modules and software to operate as described herein.

In some embodiments, master controller 150 comprises a processor and a non-transitory computer-readable medium that stores program code executable by the processor for performing various steps including, but not limited to, one or more steps described in some embodiments as being performed by generator control module 122, internal battery control module 120, charge port control module 105, and/or control feedback module 118.

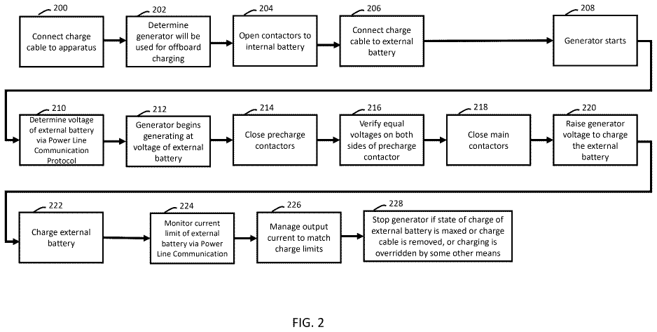

Referring now to the flow chart of FIG. 2, an exemplary flowchart to perform a method for provisioning charge to an external battery (e.g., external battery 116) from an onboard generator, such as generator 102 of apparatus 100 of FIG. 1A is provided according to some embodiments. Some or all of the operations illustrated in FIG. 2, and described in further detail below, may correspond to non-transitory, processor-executable instructions that are stored, for example, in a memory, and executed, for example, by an electronic controller, processing unit, dedicated control module, logic circuit, or other module or device or network of modules/devices to perform any or all of the above and below described functions associated with the disclosed concepts. It should be recognized that the order of execution of the illustrated operation blocks may be changed, additional operation blocks may be added, and some of the herein described operations may be modified, combined, or eliminated.

The exemplary method of FIG. 2 begins at block 200, with a charge cable (e.g., charge cable 128 of apparatus 100), being connected to an apparatus, such as, for example, to charge port 104 of apparatus 100 of FIG. 1A. Moving next to block 202, there is a determination that a generator of an apparatus (e.g., generator 106 of apparatus 100) will be used for offboard charging, such as, for example, to charge external battery 106 of FIG. 1A. This determination 202 may be made in a plurality of ways, including, but not limited to, a manual input (such as a switch that an operator may flip) that indicates to an apparatus (e.g., apparatus 100) that it is to provide power from an onboard generator (e.g., onboard generator 102). This determination 202 may also be made, for example, utilizing a second charge port that is configured to only produce energy. This determination 202 may also be made by, for example, charge port control module 105 determining that a unique resistance of charge cable 128 is coupled to charge port 104. One exemplary technique for determining that a device being plugged in (e.g., being plugged in to charge port 104 of apparatus 100 of FIG. 1A) is configured to receive charge (e.g., external battery 116 of FIG. 1A) is to use a charge cable (e.g., charge cable 128) that has a unique resistance value. In some embodiments, charge port control module 105 determines that a charge cable (e.g., charge cable 128) with a unique resistance value is coupled to charge port 104 (such as, for example, by using Ohm's law to determine the unique resistance value of the charge cable). In some embodiments, a presence of a charge cable (such as charge cable 128 of FIG. 1A) having a unique resistance value in a charge port (such as charge port 104 of FIG. 1A) may indicate a signal to be generated (by, for example, charge port controller 105) indicating that an apparatus (such as apparatus 100 of FIG. 1A) is to provide power to an external battery (such as external battery 116) using an onboard generator (such as generator 106 of FIG. 1A) and which may allow the method to move to the next step.

Upon a determination (FIG. 2, 202) that an onboard generator (e.g., generator 106 of apparatus 100 of FIG. 1A) is to provide power to an external battery (e.g., external battery 116 of FIG. 1A), the exemplary method of FIG. 2 may proceed to step 204 in which one or more contactors to an internal battery of the apparatus (e.g., internal battery contactors 136 and 138 to internal battery 106 of apparatus 100) are opened so that no power flows to or from the internal battery. In various embodiments, performance of step 204 may ensure that the internal battery is not affected (e.g., charged or discharged) by an interaction between an onboard generator and an external battery (e.g., interaction between onboard generator 102 and external battery 116). In some embodiments, at step 204, the contactor(s) to the internal battery may be opened or closed using an internal battery control module, such as internal battery control module 120 of apparatus 100 of FIG. 1A.

Upon disconnecting the internal battery (step 204), the exemplary method of FIG. 2 may proceed to step 206, wherein a charge cable (e.g., charge cable 128) is connected to an external battery (e.g., external battery 116). In some embodiments, the external battery (e.g., external battery 116) may communicate with the apparatus, (e.g., charge port control module 105 and/or master controller 150) using standardized protocols, such as Power Line Communication, and confirm that the external battery is coupled to a charge port (e.g., to charge port 104).

The exemplary method of FIG. 2 may proceed to step 208, in which an onboard generator (e.g., generator 102) is started. In some embodiments, for example, a generator control module (such as generator control module 122 in FIG. 1A) may receive a signal indicating the generator is to start (e.g., from charge port control module 105 and/or master controller 150) and may cause the onboard generator to start. Step 208 may include, for example, starting an engine that is configured as a component of an onboard generator (e.g., generator 102 in FIG. 1A), but may not require that the generator begin producing power.

The exemplary method shown in FIG. 2 may proceed to step 210, wherein the voltage of the external battery (e.g., of external battery 116) is determined. In some embodiments, an external battery, such as external battery 116 of FIG. 1A, may be configured to communicate the state of charge of the external battery, using, for example, a standard Power Line Communication Protocol, and an apparatus (e.g., apparatus 100) may be configured to receive and interpret the communication, using, for example, a processor and a non-transitory computer-readable medium that stores program code executable by the processor (e.g., charge port control module 105 and/or master controller 150).

The exemplary method may proceed to step 212, wherein an onboard generator (e.g., generator 102 in FIG. 1A) begins generating at a voltage equal to, or substantially equal to, the voltage of an external battery (e.g., of external battery 116 in FIG. 1A). In some embodiments, for example, a processor and a non-transitory computer-readable medium that stores program code executable by the processor, such as generator control module 122 in FIG. 1A, may be configured to receive a signal, for example, from charge port control module 105, that indicates a voltage of the external battery. In some embodiments, generator control module (e.g., generator control module 122) may respond to a received signal by adjusting the output of the onboard generator (e.g., generator 102 in FIG. 1A) to match an indicated voltage of the external battery (e.g., external battery 103 in FIG. 1A). In some embodiments, a master controller, such as master controller 150, may be configured to execute instructions to adjust an output of an onboard generator, such as generator 102 in FIG. 1A.

In FIG. 2, the exemplary method may advance to step 214, wherein precharge contactors are closed, such as precharge contactors 110 of FIG. 1A. In some embodiments, a processor and a non-transitory computer-readable medium that stores program code executable by the processor (e.g., of high voltage distribution module 108 in FIG. 1A), may receive a signal indicating to close the precharge contactors, for example, from master controller 150 or generator control module 122 in FIG. 1A, and may close the contactors, (e.g., precharge contactors 110).

As shown in FIG. 2, the exemplary method may proceed to step 216, in which verifying that the voltages on both sides of the precharge contactor(s) (e.g., precharge contactors 112) are equalized is performed. In some embodiments, a processor and a non-transitory computer-readable medium that stores program code executable by the processor (e.g., control feedback module 118 of FIG. 1A) may be configured to, for example, determine the voltage drop across precharge contactor(s) (e.g., precharge contactors 110). Once, for example, the processor and non-transitory computer-readable medium that stores program code executable by the processor (e.g., control feedback module 118 of FIG. 1A) has determined that the voltages on both sides of the precharge contactor are equal, or substantially equal (e.g., voltage values are approximately 99% (e.g., 99.326%) of each other or a higher percentage), then the processor and non-transitory computer-readable medium that stores program code executable by the processor (e.g., control feedback module 118 of FIG. 1A) may be configured to generate a signal instructing that a high voltage distribution module (e.g., high voltage distribution module 108) close main contactors (e.g., main contactors 112).

The exemplary method may proceed to step 218 (FIG. 2) wherein a high voltage distribution module (e.g., high voltage distribution module 108) may receive a signal indicating to close the main contactors (e.g., main contactors 112), allowing current to flow freely between an onboard generator (e.g., generator 102) and an external battery (e.g., external battery 116).

The exemplary method of FIG. 2 may continue to step 220 wherein a generator (e.g., generator 102) may produce a voltage sufficient to charge the external battery (e.g., external battery 116). In an exemplary embodiment, a generator control module, such as generator control module 122 of FIG. 1A, may receive a signal indicating to raise the voltage of an onboard generator, such as generator 102, to a charging voltage, and the generator control module may, in response to such signal, cause the onboard generator to raise its voltage. In some embodiments, a charging voltage may be determined using a processor and a non-transitory computer-readable medium that stores program code executable by the processor (e.g., generator control module 122, charge port control module 105, and/or master controller 150), which may receive, for example, from the external battery (e.g., external battery 116) using a standard Power Line Communication Protocol, a charging voltage. In some embodiments, a generator control module (e.g., generator control module 122) may use a charging voltage received from an external battery (e.g., external battery 116) to set an onboard generator (e.g., generator 102) at a charge rate voltage.

The exemplary method of FIG. 2 may continue to step 222, wherein an external battery, such as external battery 116 of FIG. 1A, is charging (e.g., receiving charge from onboard generator 102 via main contactors 112 and pre-charge contactors 110 of high voltage distribution module 108, and charge port 104).

The exemplary method of FIG. 2 may continue to step 224, wherein a current limit of an external battery, such as external battery 116 of FIG. 1A, may be monitored while the external battery is charging. In some embodiments, the external battery, such as external battery 116 of FIG. 1A, may be configured to monitor the ongoing current, against stored current limits, using a processor, memory, and/or computer-readable instructions. In some embodiments, the external battery, such as external battery 116 of FIG. 1A, may be configured to communicate charge and/or current limits, for example, using a Power Line Communication Protocol to, for example, a processor and a non-transitory computer-readable medium that stores program code executable by the processor (e.g., charge port control module 105 and/or master controller 150 of apparatus 100 in FIG. 1A).

The exemplary method of FIG. 2 may continue to step 226 wherein an output current of an onboard generator (e.g., generator 102) is adjusted (for example, by master controller 150 and/or generator control module 122) to match charge limits of the external battery (e.g., external battery 116), as may be determined in step 224 of the exemplary method. Managing an output current may be achieved, for example, using generator control module 122 of FIG. 1A to adjust the onboard generator (e.g., generator 102) to output the desired current.

As shown in step 228 of FIG. 2, the exemplary method may include stopping an onboard generator (e.g., generator 102 of FIG. 1A). In some embodiments, stopping an onboard generator may include a generator control module (e.g., generator control module 122) causing the generator (e.g., generator 102) to cease the production of power, stopping the generator's engine, or both. In some embodiments, an onboard generator (e.g., generator 102) may cease production of power when the external battery (e.g., external battery 116) has reached its maximum capacity, as may be indicated using the Power Line Communication Protocol (e.g., to charge port controller 105 or master controller 150, and to generator control module 122). In some embodiments, an onboard generator (e.g., generator 102) may be triggered to cease production of power if the charge cable (e.g., charge cable 128) is removed, or if there is an attempt to remove it (e.g., as determined by the charge port control module 105 or the master controller 150 and communicated to generator control module 122). In some embodiments, an onboard generator (e.g., generator 102) may be stopped if the charging operation is overridden by some other means (e.g., manually, if master controller 150 or generator control module 122 determines that is unsafe to continue running the generator, etc.).

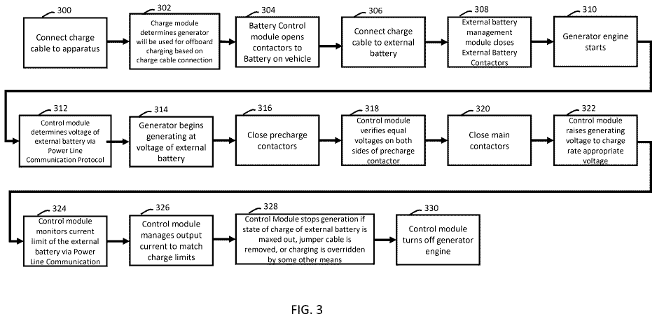

Referring now to FIG. 3, an exemplary method is illustrated for provisioning power to an external battery (e.g., external battery 116) from an onboard generator, (e.g., generator 102 of apparatus 100 of FIG. 1A). Some or all of the operations illustrated in FIG. 3 and described in further detail below may correspond to non-transitory, processor-executable instructions that are stored, for example, in a memory and executed, for example, by an electronic controller, processing unit, dedicated control module, logic circuit, or other module or device or network of modules/devices to perform any or all of the above and below described functions associated with the disclosed concepts. It should be recognized that the order of execution of the illustrated operation blocks may be changed, additional operation blocks may be added, and some of the herein described operations may be modified, combined, or eliminated.

The exemplary method of FIG. 3 may begin at block 300, with a charge cable (e.g., charge cable 128 of apparatus 100) being connected to an apparatus, such as, for example, to charge port 104 of apparatus 100 of FIG. 1A.

Moving next to block 302 (FIG. 3), a determination that a generator of an apparatus (e.g., generator 106 of apparatus 100) will be used for offboard charging, such as to charge external battery 106 of FIG. 1A, may be made. This determination (302) may be made in a plurality of ways, including, but not limited to, a manual input (such as a switch that an operator may flip) that indicates to the apparatus that it is to provide power from the onboard generator, utilizing a second charge port that is configured to only produce energy, or by, for example, a charge port control module 105 determining that a unique resistance of the charge cable (e.g., charge cable 128) is coupled to the charge port (e.g., charge port 104). One exemplary method for determining the device being plugged in (e.g., being plugged in to charge port 104 of apparatus 100 of FIG. 1A) is configured to receive charge (e.g., external battery 116) is to use a charge cable (e.g., charge cable 128) that has a unique resistance value. In some embodiments, a charge port control module (e.g., charge port control module 105) may determine that a charge cable with a unique resistance value is coupled to charge port 104 (for example, using Ohm's law to determine the unique resistance of the charge cable). In some embodiments, a presence of a charge cable (such as cable 128 of FIG. 1A) having a unique resistance value in a charge port (such as charge port 104 of FIG. 1A) may indicate a signal to be generated (by, for example, charge port controller 105) indicating that an apparatus (such as apparatus 100) is to provide power to an external battery (such as external battery 116) using an onboard generator (such as generator 106 of FIG. 1A) and which may allow the method to move to the next step.

Upon a determination (step 302) that the onboard generator (e.g., generator 106 of apparatus 100 of FIG. 1A) is to provide power to an external battery (e.g., external battery 116 of FIG. 1A), the exemplary method of FIG. 3 may proceed to step 204 in which one or more contactors to an internal battery of the apparatus (e.g., internal battery contractors 136 and 138 to internal battery 106 of apparatus 100) may be opened so that no power flows to or from the internal battery. In various embodiments, performance of step 204 may ensure that the internal battery is not affected (e.g., charged or discharged) by an interaction between the onboard generator and the external battery (e.g., by an interaction between onboard generator 102 and external battery 116). In some embodiments, at step 204, the contactor(s) to the internal battery may be opened or closed using an internal battery control module, such as internal battery control module 120 of apparatus 100 of FIG. 1A.

Upon disconnecting the internal battery (step 304), the exemplary method of FIG. 3 may proceed to step 306, wherein the charge cable (e.g., charge cable 128) may be connected to an external battery (e.g., external battery 116). In some embodiments, the external battery (e.g., external battery 116) may communicate with the apparatus, (e.g., charge port control module 105 and/or master controller 150) using standardized protocols, such as Power Line Communication and confirm that the external battery is coupled to the charge port (e.g., charge port 104).

The exemplary method of FIG. 3 may proceed to step 308, wherein an external battery management module (e.g., a component of external battery 116) may determine that an external battery (e.g. external battery 116) is to be charged and closes external battery contactors (e.g., component(s) of external battery 116) to allow current to flow to external battery (e.g., external battery 116). The exemplary method of FIG. 3 may proceed to step 310, in which an onboard generator (e.g., generator 102 in FIG. 1A) is started. In some embodiments, for example, a generator control module (such as generator control module 122 in FIG. 1A) may receive a signal indicating a generator is to start (e.g., from charge port controller 105 and/or master controller 150) and may cause the generator to start. This may include starting an engine that is configured as a component of an onboard generator (e.g., generator 102 in FIG. 1A), but may not require that the generator begin producing power.

Next, the exemplary method shown in FIG. 3 may proceed to step 312, wherein the voltage of the external battery (e.g., external battery 116) may be determined. In some embodiments, an external battery, such as external battery 116 of FIG. 1A, may be configured to communicate the state of charge of the external battery, using, for example, a standard Power Line Communication Protocol, and an apparatus (e.g., apparatus 100) may be configured to receive and interpret the communication, using, for example, a processor and a non-transitory computer-readable medium that stores program code executable by the processor (e.g., charge port control module 105 and/or master controller 150).

The exemplary method may proceed to step 314, wherein an onboard generator (e.g., generator 102 in FIG. 1A) begins generating at a voltage equal to, or substantially equal (e.g., voltage values are approximately 99% (e.g., 99.326%) of each other or a higher percentage), the voltage of an external battery (e.g., external battery 116 in FIG. 1A). In some embodiments, for example, a processor and a non-transitory computer-readable medium that stores program code executable by the processor, such as generator control module 122 in FIG. 1A, may be configured to receive a signal, for example, from charge port control module 105, that indicates a voltage of the external battery. In some embodiments, generator control module (e.g., generator control module 122) may respond to a received signal by adjusting the output of an onboard generator (e.g., generator 102 in FIG. 1A) to match an indicated voltage of the external battery (e.g., external battery 116 in FIG. 1A). In some embodiments, a master controller, such as master controller 150, may be configured to execute instructions to adjust an output of an onboard generator, such as generator 102 in FIG. 1A.

With continuing reference to FIG. 3, the exemplary method described therein may advance to step 316, wherein precharge contactors, such as precharge contactors 110 of FIG. 1A, may be closed. In some embodiments, a processor and a non-transitory computer-readable medium that stores program code executable by the processor (e.g., of high voltage distribution module 108 in FIG. 1A), may receive a signal indicating to close the precharge contactors, for example, from master controller 150 or generator control module 122 in FIG. 1A, and may close the contactors (e.g., precharge contactors 110) in response to the received signal.

As shown in FIG. 3, the exemplary method may proceed to step 318, in which verifying that the voltages on both sides of the precharge contactor(s) (e.g., precharge contactors 112) are equalized may be performed. In some embodiments, a processor and a non-transitory computer-readable medium that stores program code executable by the processor (e.g., control feedback module 118 of FIG. 1A) may be configured to, for example, determine the voltage drop across precharge contactor(s) (e.g., precharge contactors 110). In some embodiments, once a processor and a non-transitory computer-readable medium that stores program code executable by the processor (e.g., control feedback module 118 of FIG. 1A) has determined that the voltages on both sides of the precharge contactor are equal, or substantially equal (e.g., voltage values are approximately 99% (e.g., 99.326%) of each other or a higher percentage), the processor and non-transitory computer-readable medium that stores program code executable by the processor (e.g., control feedback module 118 of FIG. 1A) may be configured to generate a signal instructing that a high voltage distribution module (e.g., high voltage distribution module 108) close main contactors (e.g., main contactors 112).

The exemplary method may proceed to step 320, wherein a high voltage distribution module (e.g., high voltage distribution module 108) may receive a signal indicating to close the main contactors (e.g., main contactors 112), in order to allow current to flow freely between an onboard generator (e.g., generator 102) and an external battery (e.g., external battery 116).

The exemplary method of FIG. 3 may continue to step 322, wherein an onboard generator (e.g., generator 102) may produce a voltage sufficient to charge the external battery (e.g., external battery 116). In some embodiment a generator control module, such as generator control module 122 of FIG. 1A, may receive a signal indicating to raise the voltage of an onboard generator, such as generator 102, to a charging voltage, and, in response to such signal, a generator control module may cause the onboard generator to raise its voltage. In some embodiments, a charging voltage may be determined using a processor and a non-transitory computer-readable medium that stores program code executable by the processor (e.g., generator control module 122, charge port control module 105, and/or master controller 150), which may receive, for example, from the external battery (e.g., from external battery 116), using a standard Power Line Communication Protocol, a charging voltage. In some embodiments, a generator control module (e.g., generator control module 122) may use a charging voltage received by an external battery (e.g., external battery 116) to set an onboard generator (e.g., generator 102) at a charge rate voltage.

The exemplary method of FIG. 3 may continue to step 323, wherein an external battery, such as external battery 116 of FIG. 1A, is charging (e.g., receiving charge from onboard generator 102 via main contactors 112 and pre-charge contactors 110 of high voltage distribution module 108, and charge port 104).

The exemplary method of FIG. 3 may continue to step 324, wherein a current limit of an external battery, such as external battery 116 of FIG. 1A, may be monitored while the external battery is charging. In some embodiments, the external battery, such as external battery 116 of FIG. 1A, may be configured to monitor the ongoing current against stored limits using a processor, memory, and/or computer-readable instructions. In some embodiments, the external battery, such as external battery 116 of FIG. 1A, may be configured to communicate charge and/or current limits, for example, using a Power Line Communication Protocol to, for example, a processor and a non-transitory computer-readable medium that stores program code executable by the processor (e.g., charge port control module 105 and/or master controller 150 of apparatus 100 in FIG. 1A).

Referring to step 326 of FIG. 3, an output current of an onboard generator (e.g., generator 102) may be adjusted (for example, by master controller 150 and/or generator control module 122) to match charge and/or current limits of an external battery (e.g., external battery 116), as may be determined in step 324 (FIG. 3). Managing an output current may be achieved, for example, using a generator control module (e.g., generator control module 122 of FIG. 1A) to adjust an onboard generator (e.g., onboard generator 102) to output the desired current.

Referring to step 328 of FIG. 3, stopping an onboard generator (e.g., generator 102 of FIG. 1A) may be performed. In some embodiments, stopping an onboard generator may include a generator control module (e.g., generator control module 122) and/or master controller 150 causing the generator (e.g., generator 102) to cease the production of power. In some embodiments, an onboard generator (e.g., generator 102) may receive a signal to cease production of power (e.g., from generator control module 122 and/or master controller 150) when an external battery (e.g., external battery 116) has reached its maximum capacity, as may be indicated using the Power Line Communication Protocol (e.g., to the charge port controller 105 or the master controller 150 and to generator control module 122). In some embodiments, an onboard generator (e.g., generator 102) may be triggered to cease production of power if a charge cable (e.g., charge cable) is removed, or if there is an attempt to remove it (e.g., as determined by the charge port control module 105 or the master controller 150 and communicated to generator control module 122). In some embodiments, an onboard generator (e.g., generator 102) may be stopped if the charging operation is overridden by some other means (e.g., manually, if master controller 150 or generator control module 122 determines that is unsafe to continue running the generator, etc.). In some embodiments, in step 328 of the exemplary method of FIG. 3, a charge module may turn off a generator engine, such as an engine that is a component of generator 102 of FIG. 1A.

In some embodiments of the present disclosure, an apparatus or method may be configured to provide AC power to devices (e.g., devices 142 of FIG. 1B), and in some embodiments, may even provide power to a home or other building (e.g., building 144 of FIG. 1B). Such a configuration may include an adapter (e.g., adapter 140 of FIG. 1B) for converting DC to AC. In some embodiments an adapter (e.g., adapter 140) may be configured to be coupled with a charge port of an apparatus (e.g., charge port 104 of apparatus 100 of FIG. 1B), which may, in some embodiments use a charge cable (e.g., charge cable 144 of FIG. 1B). In some embodiments, an adapter (e.g., adapter 140 of FIG. 1B) may be part of an apparatus (e.g., apparatus 100). In some embodiments, an adapter (e.g., adapter 140) may be configured to step up or step down the voltage output. An adapter (e.g., adapter 140) may be configured externally from an apparatus (e.g., apparatus 100), e.g. by plugging it into a charge port (e.g., charge port 104 of apparatus 100 of FIG. 1B), which may, in some embodiments use a charge cable (e.g., charge cable 144 of FIG. 1B). In some embodiments, an adapter (e.g., adapter 140) may be configured within an apparatus (e.g., apparatus 100 of FIG. 1B) as an additional module connected to, for example, a High Voltage Distribution Module (e.g., high voltage distribution module 108 of FIG. 1B).

In some embodiments, an exemplary method or apparatus (e.g., apparatus 100) may include software configured to mimic the operation of a grid tied fast charger (e.g., as part of master controller 150 of apparatus 100 of FIG. 1A), such that there is no additional configuration necessary for an electric vehicle (e.g., external battery 116 of FIG. 1A) to receive charge.

In some embodiments, a charge cable (e.g., charge cable 128 of FIG. 1A) may be locked in place (e.g., in charge port 104) during the charging process. In some embodiments, a charge port (e.g., charge port 104) may include a locking mechanism, for example, a mechanical pin lock that is engaged immediately after a charge cable (e.g., charge cable 128) is inserted into a charge port (e.g., charge port 104).

Moreover, aspects of the present disclosure may be implemented using a variety of computer-systems, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing exemplary machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed is:

1. An apparatus, comprising
a generator;
a charge port;
an internal battery;
a processor; and
a non-transitory machine-readable storage medium encoded with program code executable by the processor for:
determining whether the charge port is connected to an external battery and, if so, determining a state of charge of the external battery;
based on the determined state of charge of the external battery, matching a first voltage produced by the generator to a second voltage of the external battery; and
charging the external battery via the charge port and using the generator.

2. The apparatus of claim 1, wherein the charge port is configured to connect to an external power source for operations to charge the internal battery via the charge port.

3. The apparatus of claim 2, further comprising:
a charge cable configured to interact with the charge port;
the charge cable having a first resistance value, wherein the first resistance value is configured to indicate that the charge port is connected to the external battery.

4. The apparatus of claim 1, wherein the generator is configured to output a DC voltage.

5. The apparatus of claim 1, wherein the program code executable by the processor for charging the external battery is further for responding to charge limits received from the external battery.

6. The apparatus of claim 1, wherein the program code executable by the processor is further for:
prior to matching the first voltage of the generator to the second voltage of the external battery, disconnecting the internal battery from the generator.

7. The apparatus of claim 1, wherein the apparatus is a series-hybrid vehicle.

8. The apparatus of claim 1, wherein the external battery is a component of an electric vehicle.

9. The apparatus of claim 1, wherein the program code executable by the processor is further for:
upon receiving a signal indicating that the external battery charging is complete, cease production of power by the generator.

10. The apparatus of claim 1, wherein the program code executable by the processor for charging the external battery is further configured to mimic an operation of a Grid Tiered DC fast charger.

11. A method for charging an external battery, the method comprising:
connecting an external battery to a charge port, the charge port being associated with an internal battery and a generator;
determining, using a processor and a non-transitory machine-readable storage medium encoded with program code executable by the processor, the state of charge of the external battery based on a determination that the charge port is connected to the external battery;
matching a first voltage produced by the generator to a second voltage of the external battery based on the determined state of charge of the external battery; and
charging the external battery using the generator.

12. The method of claim 11, further comprising: coupling a charge cable to the charge port, wherein:
the charge cable comprises a first resistance value; and
the first resistance value is configured to indicate a connection to the external battery.

13. The method of claim 12, further comprising:
determining, using the processor and the non-transitory machine-readable storage medium encoded with program code executable by the processor, that the charge cable comprises the first resistance value;
wherein the determining that the charge port is connected to the external battery is based on the determining that the charge cable comprises the first resistance value.

14. The method of claim 11, wherein the generator is configured to output a DC voltage.

15. The method of claim 11, further comprising:
receiving charge limits from the external battery;
wherein the charging the external battery using the generator is based on the received charge limits.

16. The method of claim 15, further comprising: disconnecting the internal battery from the generator prior to matching the first voltage produced by the generator to the second voltage of the external battery.

17. The method of claim 11, wherein the internal battery, the generator, the charge port, the processor, and the non-transitory machine-readable storage medium are components of a series-hybrid vehicle.

18. The method of claim 11, wherein the external battery is a component of an electric vehicle.

19. The method of claim 11, further comprising:
receiving an indication that the external battery has reached its maximum charge capacity; and
in response to the received indication, ceasing the charging of the external battery using the generator.

20. A non-transitory machine-readable storage medium encoded with program code executable by a processor of an apparatus, the program code executable by the processor for:
determining whether a charge port of the apparatus is connected to an external battery and, if so, determining a state of charge of the external battery;
based on the determined state of charge of the external battery, matching a first voltage produced by a generator of the apparatus to a second voltage of the external battery; and
charging the external battery via the charge port and using the generator.
